(19) United States
(12) Patent Application Publication
(10) Pub. No.: US 2005/0153732 A1
(43) Pub. Date: Jul. 14, 2005

(54) Satellite-capable mobile terminals

(75) Inventors: Scott Stotelmyer, Manhattan Beach, CA (US); Daniel Paul Sullivan, Palos Verdes Estates, CA (US)

Correspondence Address: GATES & COOPER LLP;HOWARD HUGHES CENTER, 6701 CENTER DRIVE WEST, SUITE 1050, LOS ANGELES, CA, 90045, US

(73) Assignee: THE BOEING COMPANY

(21) Appl. No.: 10/755,943

(22) Filed: Jan. 13, 2004

(51) Int. Cl. H04B 1/00

(52) U.S. Cl. 455/552.1

(57) ABSTRACT

A satellite-capable mobile terminal that communicates both with terrestrial networks and a satellite network using an integrated antenna.

### BACKGROUND OF THE INVENTION

1. Field of the Invention

The present invention relates to systems and methods for wireless data transmission, and in particular to a system and method for satellite-capable mobile terminals.

2. Description of the Related Art

In recent years, there has been an increased demand for wireless communications services. Various capabilities and services are being integrated into mobile devices, as described below.

Services being added to handsets and vehicular terminals include multi-mode wireless capabilities. For example, many phones can operate in AMPS, CDMA or GSM networks providing both voice and data in cellular and PCS bands. Certain phones now have a satellite mode along with terrestrial mode with means for “to and fro” handovers.

Another service is user location determination for phones (in response to the E911 requirement). This service is usually implemented via GPS receivers and/or radio link triangulation. From this capability are possible a number of location-based services of a commercial nature, approaching consumers based on their current location and the businesses in the area.

Still another service is “Wi-Fi” or wireless local area networks. This service provides for communication through hot spots with the Internet for an “always connected” type of capability. Typical of these services are the access points available in airports. An extension of Wi-Fi called DSRC (Dedicated Short Range Communication) is envisioned for vehicles as an element of the Intelligent Transportation System. DSRC is a recent system in the evolution of vehicle connectivity for which licensed spectrum has been allocated and hardware is being developed. It will include vehicle-to-roadside communications for purposes such as compliance and toll collection. Vehicle-to-vehicle connections are critical for collision avoidance warnings.

Yet another capability is Bluetooth. It provides for close-proximity wireless connection of various devices in a personal area network. Bluetooth interfaces devices within a room or vehicle, or close-by connections from vehicles to the roadside.

Still another application is the growing segment of telematics services, such as OnStar™. These services operate through vehicular telematics units and antenna suites to the wireless infrastructure with voice and data; to enable safety and security features to drivers and passengers, as well as hands-free phone service and Internet-based traveler information. OnStar™ provides voice and data for safety and security, personal calling, and a virtual advisor (tailored Internet information) and interacts with the driver through dashboard radios There is also an intent to expand the Internet-based services with broadband connections to the vehicles providing multi-media information.

Yet still another service is satellite radio service. Many vehicles (specifically GM™ autos) have XM™ radio receivers operating through vehicle radios, with current functional modes of AM, FM, and XM. Another satellite radio service is Sirius™, which has similar capabilities from a different type of satellite constellation. These satellite services offer a large number of channels on a nationwide basis with many program options not available from conventional AM and FM radio. They are expected to be pervasive within automobiles in the future.

However, a problem exists in that, currently, these various services are provided by separate entities, and include hardware and software implementations that are not compatible. These offerings generally require separate antennas, RF equipment and processors, even though many of the functions and frequencies are similar or commensurate. A need exists, then, for a mobile communications system that integrates new and emerging mobile satellite services with terrestrial wireless communications networks in a manner that minimizes the antennas, electronics and system operation as accessed by a consumer. Such a system would be capable of effectively integrating the services described above, while providing ubiquitous coverage available from the satellite segment. Moreover, the equipment integration can substantially reduce the hardware costs in the vehicles.

However, the success of mobile satellite services has been limited by unfashionable, bulky user terminals, the high cost of equipment and services, and poor service quality. Customers, on the other hand, demand that their phones be small, light, multimedia enabled, have advanced features such as cameras and video taping, and that they provide inexpensive service virtually any place. Thus, a need exists for seamless integration of mobile satellite services, terrestrial wireless communications services, radio, entertainment and information services into terminals, handsets and other devices. One way to provide such a service is to design and deploy a new mobile communication system that integrates all of these capabilities, as well as effecting the ubiquitous solution availed by the satellite segment. The present invention provides such a system. One such embodiment is a user terminal and handset with all terrestrial wireless functions, including satellite radio and the two-way satellite wireless communications.

### SUMMARY OF THE INVENTION

To address the requirements described above, the present invention discloses a satellite-capable mobile terminal that communicates with a terrestrial network and a satellite network, and receives digital satellite radio, using an integrated antenna and common electronics and processors.

### BRIEF DESCRIPTION OF THE DRAWINGS

Referring now to the drawings in which like reference numbers represent corresponding parts throughout:

FIG. 1 is a diagram showing an exemplary mobile communication system according to the preferred embodiment of the present invention.

FIG. 2 illustrates the components of a satellite-capable terminal according to the preferred embodiment of the present invention.

### DETAILED DESCRIPTION OF PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

Overview

The present invention comprises a mobile communications systems that includes both mobile satellite services and terrestrial wireless communications services. This system uses a new paradigm of adapting satellites to connect to commercial terminals with minimum modification. These satellite-capable terminals are low in cost and enable seamless and ubiquitous mobile communications over the world's continents. The functionality of operation over satellites is simply a feature in the handsets and vehicular terminals.

The present invention envisions terrestrial handsets that, with a minimum of modifications, access competitive communications services by satellite. This hybrid system will provide communication services to mass consumer, commercial, and government markets (i.e. telematics, maritime, aeronautical, etc.).

The present invention serves a mix of market segments, which is essential to a successful satellite-capable business. For example, the combination of government, maritime, rural, telematics, and other vertical markets provides sufficient revenue to support a profitable business.

The key advantages of the present invention include:
Provision for continent-wide ubiquitous mobile communications services with the flexibility to support multiple user populations, while aggressively re-using terrestrial terminal designs, chipsets, protocols, and network infrastructure.
A minimally modified satellite-capable mobile terminal design competitive with existing and planned terrestrial mobile terminals with all of the advanced features, such as Internet access and cameras.
An offering of ubiquitous mobile satellite services through existing terrestrial service providers, as a low-cost feature to their current service plans. This enables expansion into new markets, and growth, without having to invest heavily in expensive terrestrial infrastructure.
The leveraging of current terrestrial network architectures and infrastructure (e.g. roaming protocols) in implementing the satellite capability.

The user populations that will be supported by satellite include:
a) Transient and permanent remote-area users, utilizing handheld, transportable, and fixed terminals;
b) Vehicle telematics terminals, especially for subscriber-based safety services;
c) Professional mobile radio services, including commercial, and local, state, and national public safety;
d) Private, commercial, and government maritime communications; and
e) Aeronautical applications for non-safety-of-flight, operational, administrative, passenger services, and general aviation.

System Description

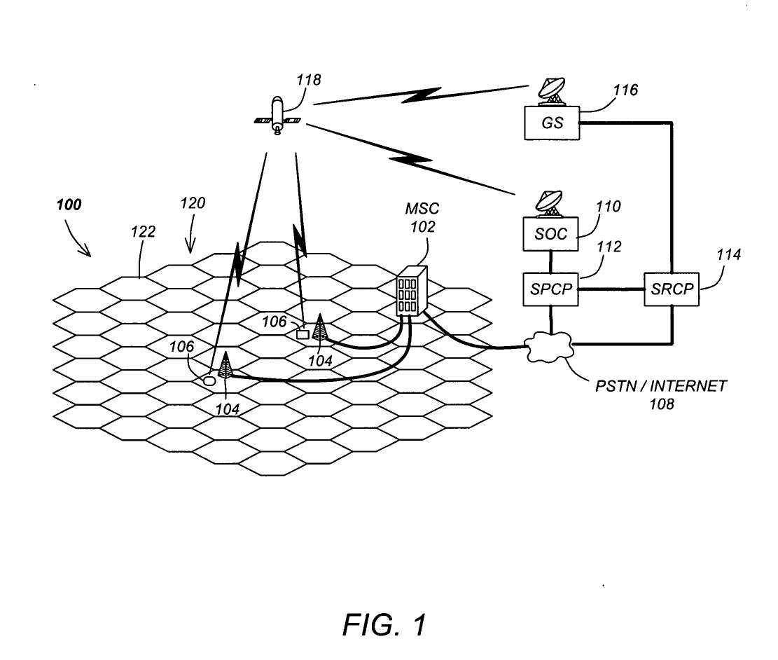

FIG. 1 is a diagram showing an exemplary mobile communication system 100 according to the preferred embodiment of the present invention.

The mobile communication system 100 includes one or more satellite communications networks and one or more terrestrial wireless communications networks, as well as interconnected public switched telephone networks (PSTNs) and Internet Protocol (IP) networks. The terrestrial wireless communications network may comprise one or more interconnected cellular and personal communications systems (PCS) networks (e.g., AMPS, GSM, TDMA, or CDMA cellular networks), public land mobile networks (PLMNs), wireless local area networks (WLANs) such as Wi-Fi and DSRC; or personal area networks (PANs) such as Bluetooth.

In the example of FIG. 1, the terrestrial wireless communications network is a cellular network that includes at least one mobile switching center (MSC) 102 and one or more base transceiver stations (BTS) 104 for communicating with one or more satellite-capable mobile terminals 106, such as handsets or other transceivers. The MSC 102 connects to a PSTN 108 or IP network, which in turn interface to other networks.

Also in the example of FIG. 1, the satellite communications network includes a satellite operations center (SOC) 110, satellite payload control point (SPCP) 112, satellite resource control point (SRCP) 114, gateway station (GS) 116, as well as one or more satellites 118 for communicating with the satellite-capable mobile terminals 106. The SPCP 112 and the SRCP 114 also connect to the PSTN 108 or IP network, which in turn interfaces to other networks.

Using large deployable antennas, beam forming phase arrays, flexible channelizers, and high-power satellites 118, the present invention provides continent-wide ubiquitous coverage for satellite-capable mobile terminals 106.

As an example of beam coverage, FIG. 1 shows a single satellite cell 120, which overlaps on some large number of terrestrial cells 122. Approximately 250 satellite cells 120 are required to cover the US and Canada, while the number of terrestrial cells 122 in each satellite cell 120 is very large, with the precise number dependent on the aggregate beamwidth of the terrestrial cells and the density of these cells 122 (and thus may differ significantly). For each satellite cell 120, however, beamwidth is approximately 0.38 degrees along the short axis, which provides a beam diameter between 150 and 190 miles.

Benefits of Satellite Services

There are a number of benefits to terrestrial wireless communications networks resulting from the use of mobile satellite services. One benefit is the mobile satellite services' ubiquitous coverage as an alternative network option. Another benefit is surge capacity to overcome congestion in the terrestrial wireless communications networks. Mobile satellite services also transcend cell outages in the terrestrial wireless communications networks, while still providing a common service level. Mobile satellite services only require a small increment over terrestrial wireless communications networks in pricing, yet provide a competitive advantage that helps reduce subscriber churn and improve customer satisfaction.

It is believed that the addressable market for satellite-capable mobile, fixed, and transportable terminals 106 is in the tens of millions of units. This market is not only continental, but global in reach. This market is being driven by the following:

TABLE
Satellite-Capable Service Market Drivers

| | |
|---|---|
| Telematics | Telematics applications, such as safety and security, |
| | require universal coverage, both in areas under-served by |
| | any mobile provider, and in areas that are not covered by |
| | the relationships between the telematics provider and |
| | the communications provider. |
| Service Area | As a low-cost alternative for communications service |
| Expansion | providers to extend their branded coverage and |
| | applications into areas where they do not have terrestrial |
| | infrastructure or spectrum, or cooperative agreements |
| | with existing operators. |
| Public Safety | Emerging interoperability and assured access |
| Interoperability | requirements for public safety organizations at all |
| | levels of government and industry, including seamless |
| | interoperability between commercial and APCO/TETRA |
| | operators; |
| Mobile | An assured-access universal coverage alternative for |
| Transportation | mobile transportation applications such as vehicle and |
| Alternatives | cargo tracking, dispatch, and routing. |

A satellite-capable terminal 106 is thus an attractive opportunity to capture and lock in additional market share over and above the standard churn of mass-market mobile products.

Satellite-Capable Mobile Terminal

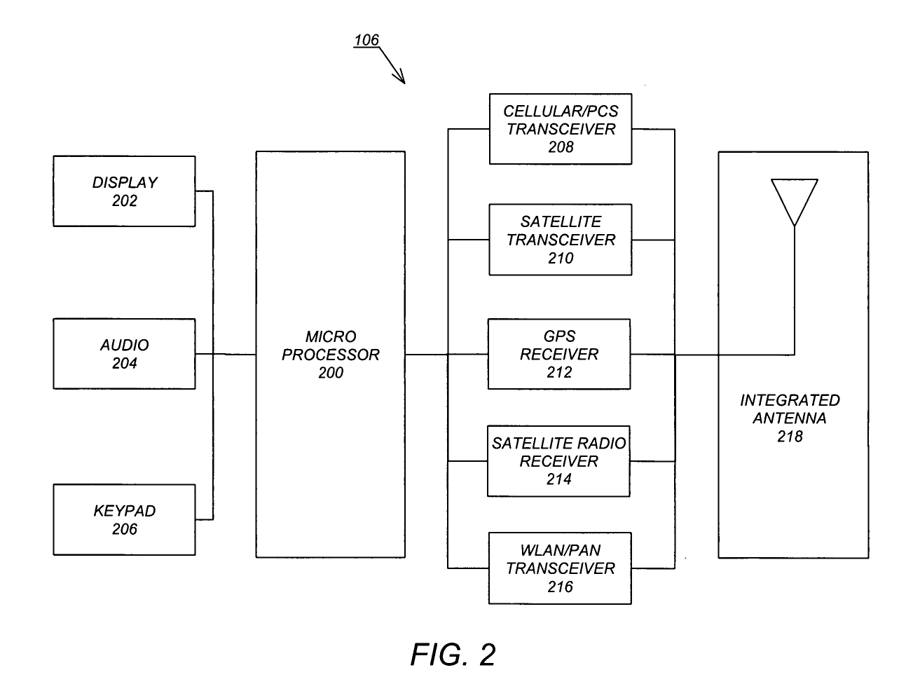

FIG. 2 illustrates the components of the satellite-capable terminal 106, including a microprocessor 200 for controlling the terminal's 106 operations; one or more input/output components coupled to the microprocessor 200, such as display 202, audio 204 and keypad 206, for inputting and outputting data as directed by the processor; a plurality of transmit/receive components coupled to the microprocessor 200 for communicating with a plurality of communications networks as directed by the processor, wherein the transmit/receive components include a terrestrial cellular/PCS transceiver 208 for communicating with a terrestrial network, a satellite transceiver 210 for communicating with a satellite network, a GPS receiver 212 for receiving signals from GPS satellites, a satellite radio receiver 214 for receiving satellite radio broadcasts, and a WLAN/PAN transceiver for communicating with other WLAN/PAN elements, so that the terminal 106 functions as a node in an ad hoc network of other wireless terminals allowing communication among the terminals; and an integrated antenna 218, such as a linear polarization handset antenna, coupled to the transmit/receive components, such as transceivers 208, 210 and 216 and receivers 212 and 214, for communicating with the communications networks.

In this context, the satellite-capable mobile terminal 106 supports both satellite and terrestrial networks. While there are several methods and scenarios for network selection, the terminal 106 will normally search for a satellite 118 connection when no terrestrial connection can be found. For certain applications, such as data retrieval from vehicles, a satellite 118 connection may be the only communications link implemented.

It is expected that the terminal 106 will inter-operate with existing terrestrial service providers to provide continent-wide service coverage. Handoff between satellite and terrestrial networks can be managed using standard roaming procedures.

In the preferred embodiment, the mobile terminals 106 support CDMA 2000/CDMAone and/or UMTS (W-CDMA/GSM) satellite-capable interfaces. However, certain parts of the mobile terminal 106 must be changed for satellite 118 operation. For example, communication by geosynchronous satellite 118 introduces an unavoidable one-way delay of 250 milliseconds, and range variations within a satellite cell 120 are much greater than experienced by terrestrial cells 122. These must be accommodated in hardware or software, including changes to the existing standards. (The ETSI S-UMTS standards efforts are an example of this.) Alternately, there are a number of techniques available, beyond the standards that can be used to optimize performance over the satellite 118 link. Examples of these include higher output power, return link pilots, and diversity combining.

The nominal family of terminal 106 types and uses under consideration for are:

TABLE
Terminal Types

| | |
|---|---|
| Handheld terminal | The absolute minimum number of changes |
| (HHT) | necessary to adapt to thesatellite network, while |
| | providing at least a minimal level of voice and |
| | data communication capability. |
| Enhanced handheld | Handset accommodations for satellite capability, |
| terminal (EHHT) | including circularly polarized antenna and high |
| | power amplifier. |
| Vehicular terminal | Used for subscriber and telematics mobile services. |
| (VT) and Enhanced | Similar to the EHHT but with a vehicle-mounted |
| Vehicular terminal | exterior or interior antenna. A VT provides minimal |
| (EVT) | satellite capability at a cost point for high market |
| | penetration. An EVT has a higher-cost circularly |
| | polarized antenna and higher-power amplifier to |
| | provide better system performance. |
| Transportable | Provides high-data rate mobile services access |
| terminal (TT) | for subscribers operating from temporary locations. |
| | May be partitioned between a user interface |
| | component and a satellite-specific component, |
| | connected by a wireless interface such as Bluetooth. |
| Fixed terminal (FT) | Provides voice and high-data rate capability for |
| | fixed subscribers operating from remote areas not |
| | covered by terrestrial cellular networks. |
| Maritime terminal | Terminals available for ships in the 25-foot |
| (MarT) | range and up, with several different antenna |
| | configurations, providing voice, low-speed data, |
| | and high-speed data. For private, commercial, |
| | and government uses. |
| Aeronautical | Provides non-safety-of-flight communications for |
| terminal (AeroT) | turboprop-class general aviation through commercial |
| | jet service, including voice, low and high-speed |
| | data. For operational and passenger services data. |
| Professional Mobile | Multi-mode cellular, and satellite-capable hand |
| Radio (PMR) | held terminals for commercial, police, fire, and |
| terminal | other public safety uses. |

It is envisioned that a single standardized satellite-capable mobile chipset can be utilized by all these terminals 106. Specifically, the microprocessor 200 and transmit/receive components 208-216 may comprise a single standardized satellite-capable mobile chipset, although the input/output components 202-206 and integrated antenna 218 may also be included in the chipset.

Physical Size

The size of the satellite-capable handheld and vehicle terminals 106 should be within the range offered by manufacturers and accepted in the marketplace. It is expected that there will be a range of acceptable terminals 106, from voice-centric handsets, to PDAs that are primarily used for data communications, to specialized devices for automotive, maritime and aeronautical use.

User Interface Requirements

The terminal 106 architecture maximizes reuse between the satellite 118 and terrestrial modes, which will result in ease of use. The terminal 106 provides an indication of an active connection to either a satellite or terrestrial network. The terminal 106 also provides the capability for the user to manually switch between satellite and terrestrial networks.

Acquisition, Synchronization, and Beam Selection

For CDMA-based satellite networks, there is a system tradeoff between pilot channel power (expressed as Ec/No), terminal 106 acquisition time, and link capacity. Because satellites 118 are especially power-limited, it is desirable that forward link pilot channel power be reduced in order to maximize capacity. Acquisition timers may be affected.

Satellite Diversity

In a multiple satellite 118 system, the mobile terminal 106 or subscriber may decide to take advantage of combining signals through multiple satellites 118 to improve the SNR (signal to noise ratio) and to reduce shadowing loss probability. That is, by utilizing multiple satellites 118, the mobile terminal 106 may increase the probability of a direct line-of-sight to a satellite 118 by fully exploiting the satellite 118 path diversity capability.

Network Selection and Registration

Using the frequency and channelizer flexibility of the satellite 118, more than one network (service) provider may be supported in the coverage area and even within a beam. The procedure for network selection and registration is expected to be the same as the terrestrial networks except for some timer/window adjustments for the long and variable propagation delay.

Call Setup

It is desired to maintain the call setup times for the satellite networks close to those of the terrestrial networks. Also, it is preferred to minimize modifications to the standard call flows. Elimination of some standard but optional call flow messages may lead to shorter setup times.

Mobile-to-Mobile Calls (Optional Enhancement)

While terminal-to-terminal calls may be double-hop, single-hop terminal-to-terminal calls might be a desired optional service feature for the satellite network. They are not normally used in consumer markets because of small likelihood of two users both using the satellite network at the same time. Vertical markets such as maritime, aeronautical, and professional mobile radio are the more likely users of this service. Single-hop connections will result in a shorter, user-acceptable end-to-end voice delay, but requires more complex terminals 106, satellites 118, and gateways 116.

Authentication and Ciphering

There are two applications that require some modification in authentication and ciphering: (a) for terminals 106 that make mobile-to-mobile calls, and (b) for professional mobile radio (PMR) terminals 106. For regular mobile originating or terminating calls to/from the PSTN 108, the authentication and ciphering would be the same as terrestrial networks.

For mobile-to-mobile calls, the terminals 106 may be using different ciphers when communicating with the network to establish a call and during the actual call. This may require the terminals 106 to change their ciphers originally assigned by the network before the mobile-to-mobile call.

PMR terminals 106 require Over-The-Air Rekeying (OTAR), and multi-level encryption. Although the objective is to use a single satellite-capable chipset to support all the different user populations, the PMR feature is not required in all satellite-capable terminals 106. The PMR terminals 106 have dual-mode terrestrial PMR and satellite PMR capability, using CDMA hardware and protocols to transport PMR services.

Power Control

Because of the long satellite 118 path-delay, the CDMA fast and slow closed and open power control loops may need modification. A possible approach is to use adaptive power control (APC) that can memorize signal variations and adaptively compensate for fade frequency and depth. APC may be used to minimize capacity-robbing power control errors (PCE).

Rate Adaptation

The terminals 106 are able to adapt the data and voice rates based on the need, environment, and availability of the resources.

High Penetration Alerting

A valuable service feature for satellite networks is a high-penetration signaling channel to alert the mobile terminal 106 at a severely disadvantaged location. The alert may contain the dialed digits of the incoming caller. This allows the user to move and/or deploy the antenna 218 of the terminal 106 to receive and send calls and data. This channel is usually sent with higher power and lower data rates to increase the probability of reception.

Low-Data Rate Services

Another valuable feature closely related to high penetration alerting is low-data rate services. These are special channels that provide higher-assurance forward and return data delivery. This is useful for applications that may have to operate from severely disadvantaged locations, e.g., inside structures or after an automobile accident, when the vehicle may not be in a nominal orientation.

Handoffs

As noted above, the terminal 106 preferably operates with a terrestrial network, but handoffs occur between the terrestrial and satellite networks, wherein the terminal searches for a satellite network connection when no terrestrial network connection can be found. In addition, handoffs may occur between satellite 118 beams or between satellites 118 in the satellite network. Beam handoffs and satellite 118 handoffs are described in more detail below.

Beam Handoff

The mobile terminal 106 measures the de-spread pilot C/(N+I) received from the adjacent beams and reports measurement results to the GS 116. This function may be initiated either by the terminal 106 based on its assessment of the pilot's signal quality or at the direction of the GS 116. When the pilot signal quality is approaching a system threshold level, the mobile terminal 106 may initiate a beam handoff procedure. The beam handoff procedure consists of following:
(1) Notify the system of impending beam handoff,
(2) Transmit the same channel through two different beams, and
(3) Drop the old beam once the connection is established on the new beam.

Satellite-to-Satellite Handoff (Used if Multiple Satellites are in View)

The procedure for satellite-to-satellite handoffs are similar to beam handoffs. As directed by the GS 116, the mobile terminal 106 will need to acquire pilot tones from another satellite 118. Because of range differences, the beam-to-beam timing offsets may be larger than experienced in terrestrial networks.

In addition to the two handoff methods mentioned above, other possible handoffs include frequency handoff, CDMA code handoff, and satellite-to-terrestrial handoff.

Geo-Location and E911

GPS is required for location based services such as geolocation and E911.

Vocoders

Due to relatively limited satellite resources, vocoders need to perform well at low bit rates. Discontinuous transmission (silence removal) can reduce the need for resources. Background noise cancellation, especially for vehicle terminals 106, can improve the voice quality.

Fax and Data Services Support

The terminals 106 support circuit switched fax and data services and provide the fax/data adapters.

Satellite Radio

The terminals 106 can receive satellite 118 radio broadcasts for entertainment purposes. Such broadcasts can be received with an antenna 218 in the terminal 106 of reasonable directivity. By integrating satellite radio into the terminal 106, a number of entertainment options are available.

For example, if the terminal 106 is a phone, an automatic switchover to the satellite radio broadcasts occurs when the terrestrial transceivers 208 and satellite transceivers 210 are not in use. For example, satellite radio broadcasts may be played through the terminal 106 to entertain the user. In another example, the satellite radio broadcasts may be used for “music-on-hold” when a caller is placed on hold or when cellular or satellite service is not in use on the terminal 106. In another example, if the terminal 106 is a PC or similar device, then the satellite radio broadcasts may provide background audio when speakers of the terminal 106 are not otherwise in use.

TCP/IP Adaptation

Standard TCP/IP over geosynchronous satellites 118 can not provide efficient channel usage in the long-delay and mobile environment. Because of this, the terminal 106 provides the capability for Performance Enhancing Proxies (PEP) for supporting TCP/IP over the satellite 118. PEPs are used to “spoof” the TCP connection at each edge of the system, in the GS 116 as well as the terminal 106.

Conclusion

This concludes the description of the preferred embodiments of the present invention. The foregoing description of the preferred embodiment of the invention has been presented for the purposes of illustration and description. It is not intended to be exhaustive or to limit the invention to the precise form disclosed. Many modifications and variations are possible in light of the above descriptions. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

1. A terminal, comprising:
a processor for controlling the terminal's operations;
one or more input/output components coupled to the processor for inputting and outputting data as directed by the processor;
a plurality of transmit/receive components coupled to the processor for communicating with a plurality of communications networks as directed by the processor, wherein the transmit/receive components include a terrestrial transceiver for communicating with terrestrial networks and a satellite transceiver for communicating with a satellite network; and
an integrated antenna coupled to the transmit/receive components for communicating with the communications networks.

2. The terminal of claim 1, wherein the transmit/receive components include a satellite radio receiver for receiving satellite radio broadcasts.

3. The terminal of claim 2, wherein an automatic switchover to the satellite radio broadcasts occurs when the terrestrial and satellite transceivers are not in use.

4. The terminal of claim 2, wherein the satellite radio broadcasts are used for “music-on-hold” when a caller is placed on hold.

5. The terminal of claim 2, wherein the satellite radio broadcasts provide background audio when speakers of the terminal are not otherwise in use.

6. The terminal of claim 1, wherein the terminal searches for a satellite connection when no terrestrial connection can be found.

7. The terminal of claim 1, wherein handoffs occur between a terrestrial and a satellite network.

8. The terminal of claim 1, wherein handoffs occur between satellite beams in a satellite network.

9. The terminal of claim 1, wherein handoffs occur between satellites in a satellite network.

10. The terminal of claim 1, wherein the transmit/receive components include a wireless local area network (WLAN)/personal area network (PAN) transceiver for communicating with other WLAN/PAN devices.

11. The terminal of claim 10, wherein the mobile terminal functions as a node in an ad hoc network of other wireless terminals allowing communication among the terminals.

12. The terminal of claim 1, wherein the terminal comprises a handheld terminal.

13. The terminal of claim 1, wherein the terminal comprises a vehicular terminal.

14. The terminal of claim 1, wherein the terminal comprises a transportable terminal.

15. The terminal of claim 1, wherein the terminal comprises a fixed terminal.

16. The terminal of claim 1, wherein the terminal comprises a maritime terminal.

17. The terminal of claim 1, wherein the terminal comprises an aeronautical terminal.

18. The terminal of claim 1, wherein the terminal comprises a professional mobile radio terminal.

19. The terminal of claim 1, wherein the processor and transmit/receive components comprise a single standardized satellite-capable mobile chipset.

20. The terminal of claim 1, wherein the terminal provides a capability to manually switch between satellite and terrestrial networks.

21. In a wireless communications system comprising a plurality of communications networks, a method of operating a terminal, comprising:
(a) receiving signals from the communications networks at the terminal, wherein the terminal is comprised of a processor for controlling the terminal's operations, one or more input/output components coupled to the processor for inputting and outputting data as directed by the processor, a plurality of transmit/receive components coupled to the processor for communicating with a plurality of communications networks as directed by the processor, wherein the transmit/receive components include a terrestrial transceiver for communicating with a terrestrial network, and a satellite transceiver for communicating with a satellite network, and an integrated antenna coupled to the transmit/receive components for communicating with the communications networks.

22. The method of claim 21, wherein the transmit/receive components include a satellite radio receiver for receiving satellite radio broadcasts.

23. The method of claim 22, wherein an automatic switchover to the satellite radio broadcasts occurs when the terrestrial and satellite transceivers are not in use.

24. The method of claim 22, wherein the satellite radio broadcasts are used for “music-on-hold” when a caller is placed on hold.

25. The method of claim 22, wherein the satellite radio broadcasts provide background audio when speakers of the terminal are not otherwise in use.

26. The method of claim 21, wherein the terminal searches for a satellite connection when no terrestrial connection can be found.

27. The method of claim 21, wherein handoffs occur between a terrestrial and a satellite network.

28. The method of claim 21, wherein handoffs occur between satellite beams in a satellite network.

29. The method of claim 21, wherein handoffs occur between satellites in a satellite network.

30. The method of claim 21, wherein the transmit/receive components include a wireless local area network (WLAN)/personal area network (PAN) transceiver for communicating with other WLAN/PAN devices.

31. The method of claim 30, wherein the mobile terminal functions as a node in an ad hoc network of other wireless terminals allowing communication among the terminals.

32. The method of claim 21, wherein the terminal comprises a handheld terminal.

33. The method of claim 21, wherein the terminal comprises a vehicular terminal.

34. The method of claim 21, wherein the terminal comprises a transportable terminal.

35. The method of claim 21, wherein the terminal comprises a fixed terminal.

36. The method of claim 21, wherein the terminal comprises a maritime terminal.

37. The method of claim 21, wherein the terminal comprises an aeronautical terminal.

38. The method of claim 21, wherein the terminal comprises a professional mobile radio terminal.

39. The method of claim 21, wherein the processor and transmit/receive components comprise a single standardized satellite-capable mobile chipset.

40. The method of claim 21, wherein the terminal provides a capability to manually switch between satellite and terrestrial networks.
